(19) United States
(12) Patent Application Publication
(10) Pub. No.: US 2008/0052929 A1
(43) Pub. Date: Mar. 6, 2008

(54) Level indicator for snow plow

(75) Inventor: Gino Paonessa, Oakville (CA)

Correspondence Address: GOWLING, LAFLEUR HENDERSON LLP, ONE MAIN STREET WEST, HAMILTON, ON, L8P 4Z5, US

(73) Assignee: ADEPCO TECHNOLOGIES CORP.

(21) Appl. No.: 11/584,621

(22) Filed: Oct. 23, 2006

(30) Foreign Application Priority Data
Sep. 1, 2006 (CA) 2558339

(51) Int. Cl. B60K 37/00

(52) U.S. Cl. 33/333

(57) ABSTRACT

A level indicator for a snow plow assembly has a reference wand and a pendulum guage pivoted to the reference wand. The reference wand has a bend at a top end with a reference mark to lie over the pendulum. The pendulum guage has a counterweight to dampen its swing and has an indicator. The indicator aligns with the reference mark in a level position of the snow plow assembly and the swing of the pendulum is limited by interference with the reference wand between extreme positions where the snow plow assembly is tilted.

### FIELD OF THE INVENTION

This invention relates to a snow plow and in particular relates to a level indicator to show whether the moldboard in a snow plow is level with the ground as otherwise shoes provided to protect side plates for the moldboard will become worn.

### BACKGROUND OF THE INVENTION

In a snow plow assembly, the snow plow has a receiver for coupling to a driven vehicle. The receiver extends rearwardly from a moldboard that is forwardly curved for pushing snow that is contained between side plates for the moldboard. The side plates have bottom edges which slide on the ground or other surface being cleared of snow and are protected with so-called shoes which can be replaced, as the case may be, according to wear of the shoes. It is of course preferable to minimize the wear of the shoes as much as possible, and therefore level indicators are provided to operators of the plow so they can adjust the tilt of the moldboard in such a way as to minimize the wear on the shoes.

Level indicators in the form of pendulums fixed to the side plate are known in the art. Once such level indicator consists of a reference wand fixed to the side plate and a guage pivoted to an upper end of the reference wand. When the guage coincides with the reference wand, the snow plow unit is level and when the guage does not coincide with the reference wand, the snow plow unit is not level.

It is sometimes difficult for an operator to see whether the reference wand and the guage coincide. This is further compromised by the guage being in constant motion as the snow plow must by necessity move over uneven terrain with the result that the operator either ignores the guage or takes frequent breaks to wait for the guage to come to an equilibrium rest position.

An object of this invention is to provide an improved level indicator where the aforementioned problems are minimized.

### SUMMARY OF THE INVENTION

In accordance with this invention, there is provided a level indicator for attachment to a snow plow assembly, the level indicator having a reference wand adapted to be mounted to the snow plow assembly and a pendulum guage pivotably mounted between its ends to the reference wand. The pendulum guage has a counterweight at one end to dampen the swing of the pendulum guage and indicator means at the other end for indicating the position of the pendulum guage relative to the reference wand.

### BRIEF DESCRIPTION OF THE DRAWINGS

Preferred embodiments of the invention are described below with reference to the accompanying drawings, in which:

FIG. 1 is a perspective view of a snow plow assembly with a level indicator according to a first embodiment of the invention attached to the snow plow;

FIG. 2 is a perspective view (drawn to a larger scale) of the level indicator of FIG. 1 shown in a position where the snow plow is level;

FIG. 3 is a similar view to FIG. 1 from the other side of the level indicator;

FIG. 4 is a perspective view from the front of a second embodiment of a level indicator made in accordance with the invention; and

FIG. 5 is a perspective view from the back of the level indicator of FIG. 4.

### DESCRIPTION OF PREFERRED EMBODIMENT

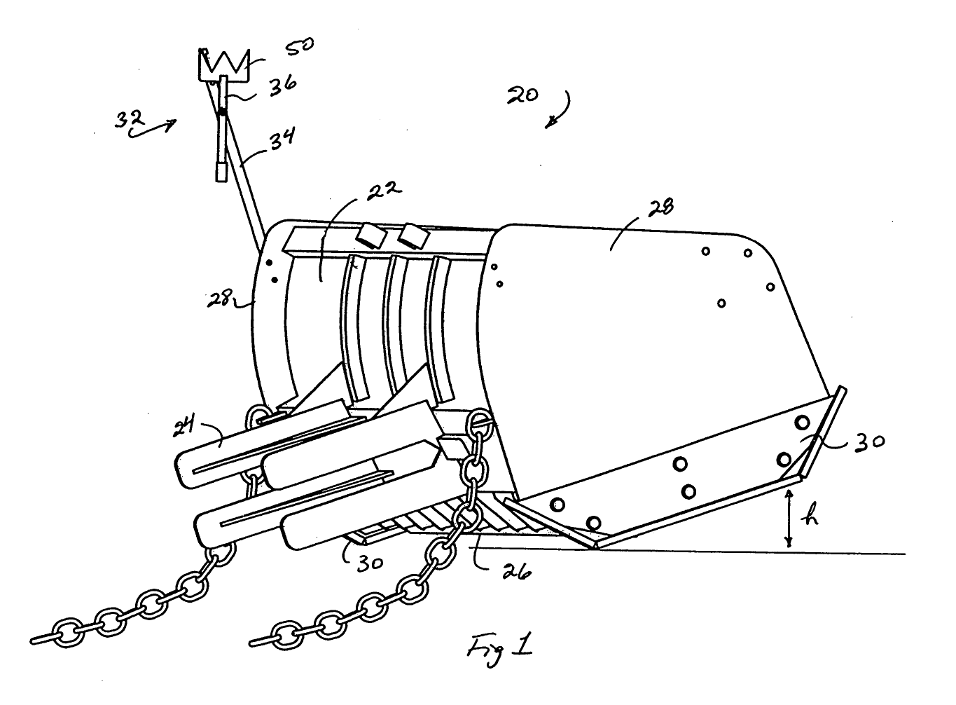

A snow plow assembly is generally indicated in the drawings by reference numeral 20 and consists of a moldboard 22 which in use is pushed by a driven vehicle (not shown) that is coupled using a receiver 24 extending rearwardly from the rear surface of the moldboard 22. The snow is scraped with a blade 26 that extends along the length of the moldboard 22 at a bottom edge thereof. Any snow pushed by the plow is contained between sides 28 that extend the full height of the moldboard 22 and forwardly. The bottom surface of each of the sides 28 is protected with a shoe 30 that is removably coupled to a side 28 and that can be replaced, as the need arises. During use, the snow plow assembly 20 is not always level and can, for example be tilted upwardly, as shown in FIG. 1 by the separation height “h” indicated at the forward end of the sides 28 which shows the height of the sides 28 above ground. This results in wear at the back of the shoes 30.

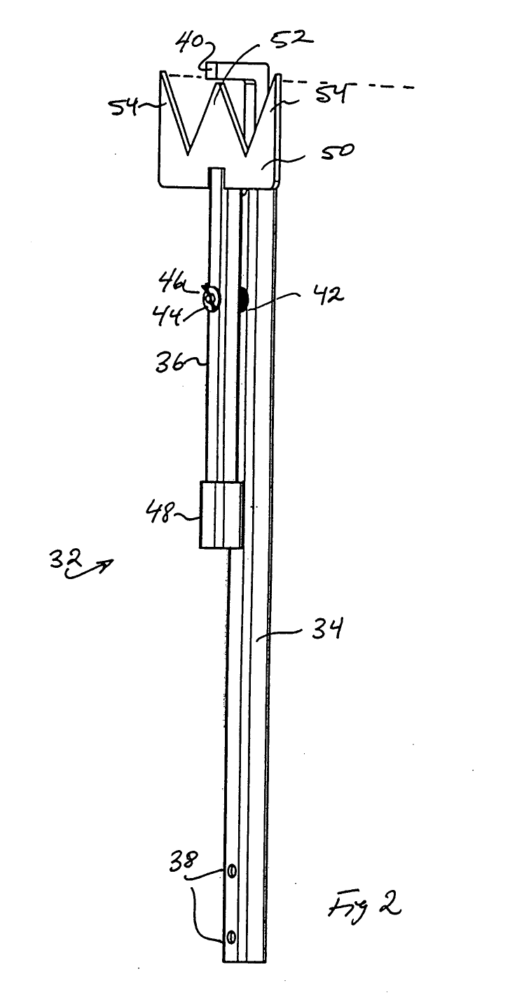

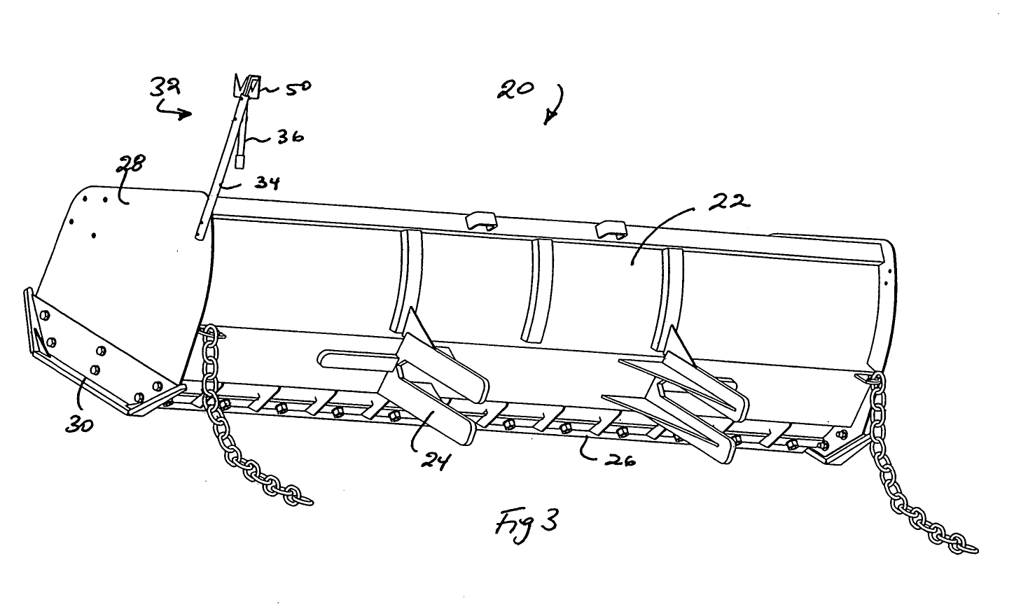

In accordance with this invention, a level indicator 32 is provided to enable an operator to more readily see the attitude of the plow assembly and to adjust its tilt, as desired. The level indicator consists of two relatively movable parts: a reference wand 34 and a pendulum guage 36. Both are shown in more detail in FIG. 2.

The reference wand 34 consists of an elongate bar which has a pair of mounting apertures 38 at a bottom end for mounting the level indicator 32 to a selected side 28 of the snow plow assembly 20 for convenient viewing by an operator seated in the driven vehicle. The top end of the reference wand 34 extends above the snow plow assembly and has a right-angle bend to define a reference mark 40 for the pendulum guage 36. The reference mark is spaced from the bottom end of the reference wand 34 and extends toward the pendulum guage 36. Preferably, the reference mark 40 will have a fluorescent or reflective coating applied so that it is more visible to an operator. The top end of the reference wand 34 may be integral with the bottom end or made separately and joined to the bottom end.

The pendulum guage 36 is in the form of an elongate bar rotatably coupled between its ends to the reference wand 34 with a pin (not shown) that traverses the body of the reference wand 34 and of the pendulum guage 36 at a height which allows their top ends to coincide, as described in more detail below. The pin receives a bushing 42 to space the pendulum guage 36 from the reference wand 34 and it is secured with a washer 44 and a cotter pin 46.

The bottom end of the pendulum guage 36 has a counterweight 48 that operates to dampen the swing of the pendulum guage 36 on the reference wand 34.

The top end of the pendulum guage 36 has indicator means 50 in the form of a three-peaked crest of which the center peak 52 is adapted to line up or coincide with the reference mark 40 of the reference wand 34 when the snow plow is level. The height of the center peak 52 above the pivot pin is somewhat less than the height separating the reference mark 40 from the pivot pin so that the center peak 52 can swing past the reference mark 40. Conveniently, the center peak 52 will also have a fluorescent or reflective coating so that it is more visible to an operator. The outer peaks 54 are disposed on opposite sides of the center peak 52 and have a somewhat greater height above the pivot pin than the center peak 52 so that they cannot swing past the reference mark 40 but will come into engagement with the top end of the reference wand 34. This configuration is shown in FIG. 1 of the drawings where the left most outer peak 54 is in engagement with the top end of the reference wand 34. The outer peaks 54 thus define swing limit means for the level indicator.

Thus, in extreme tilt positions of the snow plow, the outer peaks 54 come to rest against the reference wand 34. The separation between the outer peaks 54 may be selected to provide a greater or smaller range of sensitivity to the guage. An increase in the separation of the outer peaks will allow for greater tolerance in the tilt of the snow plow assembly. By coming to rest against the reference wand 34, the pendulum guage 36 is limited in its swing and will more readily come to an equilibrium position so that an operator can see whether the reference wand 34 and the pendulum guage 36 coincide.

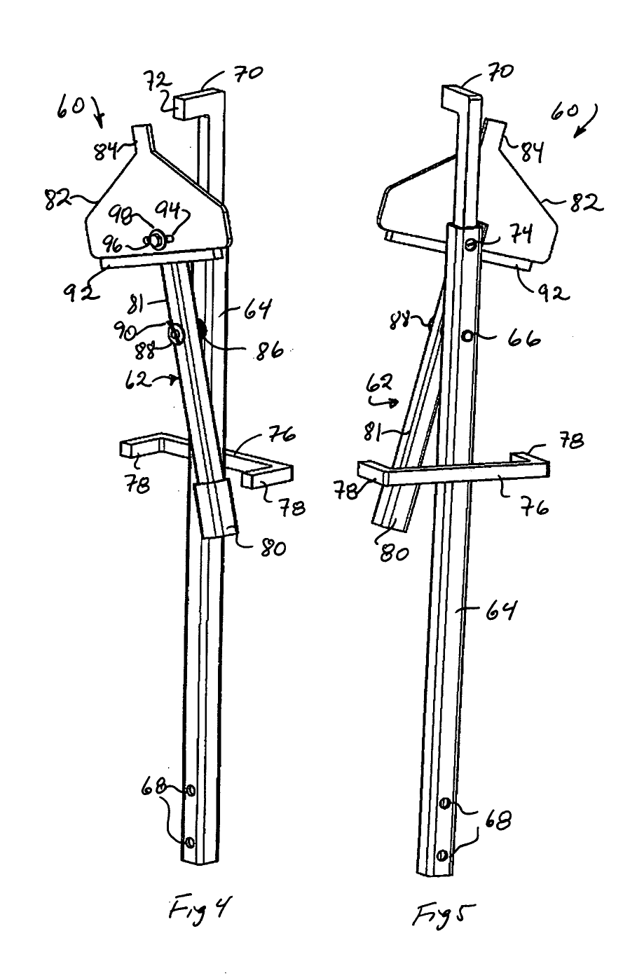

An alternative embodiment of the invention is shown in FIG. 4 and FIG. 5 of the accompanying drawings. Here the level indicator is generally indicated by reference numeral 60 and also consists of a pendulum guage 62 pivotally mounted to a reference wand 64 on a pivot pin 66.

The reference wand 64 is similar to the reference wand 34 and has a pair of spaced mounting apertures 68 at a bottom end and a right-angle bend 70 at an upper end of which the extremity defines a reference mark 72. In this embodiment, the upper end of the reference wand 64 is not integral with the bottom end and is made from tubing having a smaller diameter so that it can be slidably received in the bottom end made from somewhat larger diameter tubing. A fastener 74 secures the top end to the bottom end.

Swing limit means 76 are provided on the reference wand 64 between the upper and lower ends thereof in the form of a transversely extending U-shaped channel defining spaced side arms 78 that extend on opposite sides of the reference wand 64 and which limit swinging of the pendulum guage 62 therebetween. It will be understood that the swing limit means 76 must be positioned on the reference wand 64 at a height where there will be interference with the pendulum guage 62 during use.

The pendulum guage 62 is in the form of an elongate bar 81 and has a counterweight 80 at its bottom end to dampen the swing of the pendulum guage. A trigonal indicator 82 is fixed to the top end of the bar 81 and has a single projection 84 adapted to point to the reference mark 72 on the reference wand 64 and an opposing base that extends transversely across the bar 81. The pendulum guage 62 pivots on pivot pin 66 which traverses the body of the reference wand 72 and of the pendulum guage 62 at a height which allows their top ends to coincide. The pin receives a bushing 86 to space the pendulum guage 62 from the reference wand 64 and it is secured with a washer 86 and cotter pin 90.

To further improve the balance the pendulum guage 62, and ensure alignment between the pendulum guage and the reference wand, in an equilibrium position of the level indicator it may become necessary to add an adjustable balance weight to the indicator 82. This is shown in FIG. 4 and FIG. 5 in the form of a balance plate 92 that is secured to a bottom end of the indicator 82. The relative position of the balance plate 92 to the body of the indicator 82 is adjustable. In the embodiment shown, a slot 94 is cut into the indicator 82 and the slot extends transversely across the elongate body of the pendulum guage 62. A fastener 96 is received through a washer 98 and the slot 94 to secure the balance plate 92 to the indicator 82 in a selected position.

In the alternative, the indicator 82 may be made of material that is relatively lighter then the remainder of the pendulum guage, thereby obviating the need for a balance weight. For example, it may be possible to make the indicator 82 from a thin metal plate or to increase the mass of the counterweight 80.

In use, during extreme tilt positions of a snow plow, the pendulum guage 62 will come to rest against the side arms 78 of the swing limit means 76. In this way, the pendulum guage 62 is limited in its swing and will more readily come to an equilibrium position so that an operator can observe whether the reference wand 64 and the pendulum guage 62 coincide.

It will be appreciated that several variations may be made to the above-described preferred embodiments without departure from the spirit and intention of the applicant. In particular, the shapes of the reference wand and of the pendulum guage 36 may be changed in various ways that will be apparent to those skilled in the art so as to limit the swing of the pendulum relative to the reference wand. Accordingly, swing limit means may be provided on either the reference wand as in the case of the second embodiment or the pendulum guage, as in the case of the first embodiment. Other such variations may be made within the scope of the appended claims.

What is claimed is:

1. A level indicator for a snow plow assembly, the level indicator having a reference wand and a pendulum guage pivotably mounted to the reference wand on a pivot pin,
the reference wand extending longitudinally between a bottom end adapted for mounting to the snow plow assembly and a top end adapted to extend above the snow plow assembly, the top end having a reference mark,
the pendulum guage extending longitudinally between a bottom end and a top end, the bottom end having a counterweight to dampen swinging of the pendulum guage and disposed on one side of the pivot pin,
indicator means on a top end of the pendulum guage disposed on the other side of the pivot pin to show alignment between the pendulum guage and the reference wand, and
swing limit means on one of the pendulum guage and the reference wand adapted to engage the other of the pendulum guage and the reference wand when the snow plow assembly is in a tilted position, and to limit rotation of the pendulum guage on the pivot pin.

2. A level indicator according to claim 1 in which the top end of the reference wand has a bend to space the reference mark transversely from the bottom end of the reference wand and to extend toward the pendulum guage.

3. A level indicator according to claim 2 in which the pendulum guage has indicator means in the form of a three peaked crest, a center peak being spaced from the pivot pin by a height which is less than the height separating the reference mark on the reference wand from the pivot pin, the outer peaks defining swing limit means and being disposed on opposite sides of the center peak, the outer peaks being spaced from the pivot pin by a height which is greater than the height separating the reference mark on the reference wand from the pivot pin.

4. A level indicator according to claim 1 in which the reference mark has a distinctive color.

5. A level indicator according to claim 4 in which a reflective coating is applied to the reference mark.

6. A level indicator according to claim 4 in which a fluorescent coating is applied to the reference mark.

7. A level indicator according to claim 1 in which the indicator means has a distinctive color.

8. A level indicator according to claim 7 in which a reflective coating is applied to the indicator means.

9. A level indicator according to claim 7 in which a fluorescent coating is applied to the indicator means.

10. A level indicator according to claim 3 in which the separation between outer peaks of the swing limit means is increased to allow for greater tolerance in the tilt of the snow plow assembly.

11. A level indicator according to claim 1 in which the swing limit means is in the form of a transversely extending U-shaped channel mounted to one of said pendulum guage and the reference wand at a height where the U-shaped channel will interfere with the other of the pendulum guage and the reference wand.

12. A level indicator according to claim 1 in which the indicator has an adjustable balance weight to ensure alignment between the pendulum guage and the reference wand in an equilibrium position thereof.
